(19) United States
(12) Patent Application Publication
(10) Pub. No.: US 2015/0178606 A1
(43) Pub. Date: Jun. 25, 2015

(54) IMAGE PROCESSING APPARATUS

(71) Applicant: CANON KABUSHIKI KAISHA, Tokyo (JP)

(72) Inventor: Hidekazu Nakashio, Warabi-shi (JP)

(21) Appl. No.: 14/559,852

(22) Filed: Dec. 3, 2014

(30) Foreign Application Priority Data
Dec. 25, 2013 (JP) 2013-267688

(51) Int. Cl. G06K 15/02

(52) U.S. Cl. CPC G06K 15/1878

(57) ABSTRACT

In some cases, automatic selection of two colors closer to those of a document may increase the amount of toner consumed, as compared to user's manual selection. Provided is a device to determine a color which forms the document and perform automatic switching between modes of setting of a specified color, in which the switching enables a mode of setting in which a region of a primary color is adopted in larger amounts than a region of a secondary color.

### BACKGROUND OF THE INVENTION

1. Field of the Invention

The present invention relates to an image processing apparatus, and more particularly to image processing for printing with a reduced number of colors.

2. Description of the Related Art

Four-color CMYK printing (called full-color printing) is generally used in the field of printing. Here, C denotes cyan; M, magenta; Y, yellow; and K, black. However, the full-color printing is high in cost because of needing color materials for four colors. Under such circumstances, two-color printing as processing for printing with a reduced number of colors receives attention for purposes of cost reduction. The two-color printing is the function of printing an achromatic color portion of a color document in black, and printing a chromatic color portion thereof by performing image processing of replacing the chromatic color portion with a user-specified color (for example, CMYRGB or the like). Here, R denotes red; G, green; and B, blue.

However, color specification is troublesome to a user. Therefore, Japanese Patent Laid-Open No. 2013-183303 has proposed a method which involves analyzing pixels of image data in L*a*b* space, automatically determining one color which is large in the amount of usage, exclusive of K, and using color materials for the determined color and K to perform two-color printing.

However, in some cases, such a method may increase the amount of color materials consumed, as compared to user's manual color specification. For example, C (cyan) is made up of a primary color of a color material, whereas R (red) is made up of a secondary color as a mixture of M (magenta) and Y (yellow), and thus, in a case where R is selected by automatic determination, there is a significant increase in the amount of color materials consumed.

### SUMMARY OF THE INVENTION

An image processing apparatus according to an aspect of the present invention includes: a setting unit configured to set color regions obtained by dividing a color space into plural colors; a determination unit configured to determine a color region having the highest content of a color which forms image data, among the color regions set by the setting unit; and a decision unit configured to decide a color corresponding to the region having the highest content of the color determined by the determination unit as a specified color for use in printing of the image data, in which the setting unit sets the color regions obtained by dividing the color space such that a region of a primary color as a color corresponding to a color material for use in the printing is wider than a region of a secondary color as a color corresponding to a combination of plural colors of color materials for use in the printing.

According to the aspect of the present invention, it is possible to reduce the total amount of toner consumed for two-color printing, by automatically determining a color which forms a document.

Further features of the present invention will become apparent from the following description of exemplary embodiments (with reference to the attached drawings).

### BRIEF DESCRIPTION OF THE DRAWINGS

FIG. 1 is a block diagram of assistance in explaining a configuration of an image processing apparatus;

FIG. 2 is a representation illustrating an example of a color determination boundary line giving priority to color of a document in a case where specified colors are CMYRGB;

FIG. 3 is a flowchart illustrating exemplary processing by a color determination unit according to a first embodiment;

FIGS. 4A and 4B are representations illustrating an example of an operation panel in two-color printing setting;

FIG. 5 is a representation illustrating an example of a color determination boundary line giving priority to the color of the document in a case where intermediate colors other than CMYRGB are also selectable as specified colors;

FIG. 6 is a representation illustrating an example of a color determination boundary line giving priority to a toner saving effect in a case where specified colors are CMYRGB;

FIG. 7 is a representation illustrating an example of a color determination boundary line giving priority to the toner saving effect in a case where intermediate colors other than CMYRGB are also selectable as specified colors;

FIG. 8 is a flowchart illustrating exemplary processing by a two-color conversion table generation unit;

FIG. 9 is a representation illustrating in schematic form a color conversion table generated by the two-color conversion table generation unit;

FIG. 10 is a representation illustrating examples of output samples for two-color printing;

FIG. 11 is a flowchart illustrating exemplary processing by a color determination unit according to a second embodiment; and

FIG. 12 is a flowchart illustrating exemplary processing by a color conversion unit according to the second embodiment.

### DESCRIPTION OF THE EMBODIMENTS

Embodiments of the present invention will be described below with reference to the drawings. Note that structural elements described in the embodiments are only illustrative and are not intended to restrict the scope of the invention.

### First Embodiment

An image forming apparatus according to a first embodiment will be described as MFP (Multifunction Peripheral) including an image processing apparatus, a scanner, a print engine, and an operation unit. However, the image forming apparatus may be in any form, provided that it has a printing function.

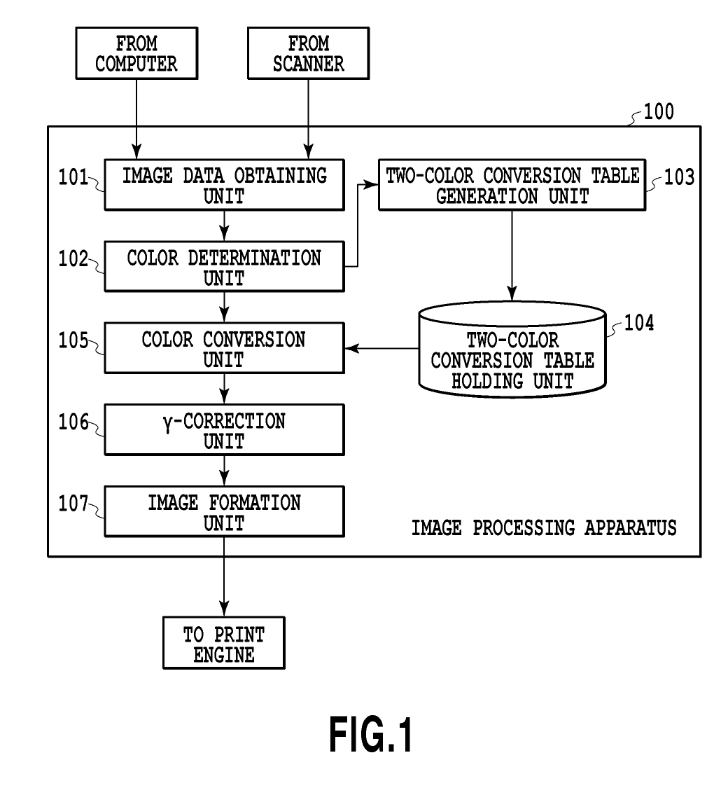

FIG. 1 is a block diagram illustrating an example of a configuration of an image processing apparatus 100. The image processing apparatus 100 according to the embodiment includes an image data obtaining unit 101, a color determination unit 102, a two-color conversion table generation unit 103, a two-color conversion table holding unit 104, a color conversion unit 105, a y-correction unit 106, and an image formation unit 107.

The image data obtaining unit 101 generates RGB image data in bitmap form and attribute information by performing rendering on print data such as PDL data received from a computer connected to the image forming apparatus. The attribute information is information to be determined in units of objects such as graphics (or figures), text (or characters) and images (or photographs). The image data obtaining unit obtains the RGB image data thus generated from the print data. Note that, in a case where a document is read by the scanner, the image data obtaining unit obtains RGB image data generated from the read document. Note that, although the RGB image data will be described by way of example in the embodiment, any image data may be used.

The color determination unit 102 extracts a pixel value by sampling the input RGB image data from the image data obtaining unit 101, and converts the pixel value into a predetermined color space. Here, description will be given assuming that the sampling is performed in order to speed up processing; however, processing may be performed without the sampling. Note that the predetermined color space refers to L*a*b*, YUV or other space having one achromatic color axis for example in a three-dimensional color space. In the embodiment, conversion into the L*a*b* space will be described; however, conversion into the YUV space may be performed.

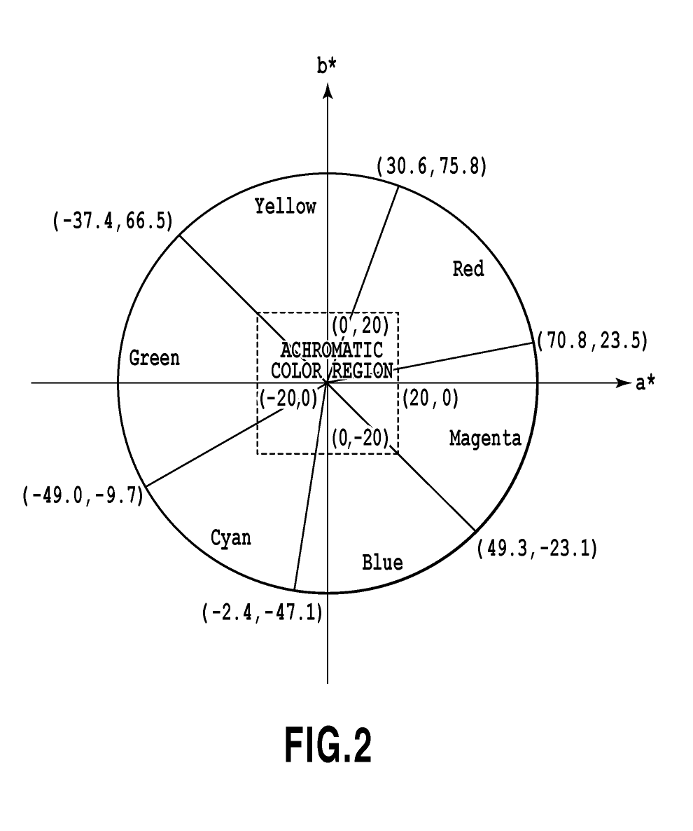

In the embodiment, as illustrated in FIG. 2, two components exclusive of a component along the achromatic color axis in the three-dimensional color space are used. For example, a chromaticity component a*b* exclusive of a lightness component L* as the component along the achromatic color axis in the L*a*b* color space is used. Note that a color difference component UV exclusive of a luminance component Y as the component along the achromatic color axis in the YUV color space may be used. A bird's eye view of a two-dimensional color plane (called a hue plane) defined by two parameters corresponding to two components associated with hue enables determining colors of pixels (CMYRGB, intermediate colors such as orange, pink, and purple, and the like). The color determination unit 102 counts results of color determination of pixels after the color conversion, for each candidate color, and sets a candidate color having the largest number of pixels as a specified color. The candidate color refers to a color as a candidate for the specified color. The specified color refers to a color for use in two-color printing and a color other than a particular color (typically, K (black)). Details of processing by the color determination unit 102 will be described later.

The two-color conversion table generation unit 103 generates a two-color conversion table (for example in the form of a lookup table) for conversion of the RGB image data into CMYK image data for two-color printing, based on the specified color set by the color determination unit 102. Details will be described later.

The two-color conversion table holding unit 104 holds the two-color conversion table generated by the two-color conversion table generation unit 103.

The color conversion unit 105 performs color conversion to convert the RGB image data obtained by the image data obtaining unit 101 into the CMYK image data for two-color printing, by using the two-color conversion table held in the two-color conversion table holding unit 104. Note that any known color conversion method such as tetrahedral interpolation or cubic interpolation may be used as a color conversion method.

The y-correction unit 106 subjects the CMYK image data fed from the color conversion unit 105 to a correction process to keep tone characteristics of the print engine constant.

The image formation unit 107 performs control to convert the CMYK image data corrected by the y-correction unit 106 into N bit(s) of halftone image data suitable for a printer and feed the halftone image data to the print engine (here, N denotes an integer). Note that any approach may be adopted in the embodiment although various approaches such as a density pattern method, a systematic dither method and an error diffusion method are proposed as halftone processing.

Note that an engine using CMYK ink, of course, may be used as the print engine although the following description of the embodiment will be given assuming that an engine using CMYK toner is used as the print engine.

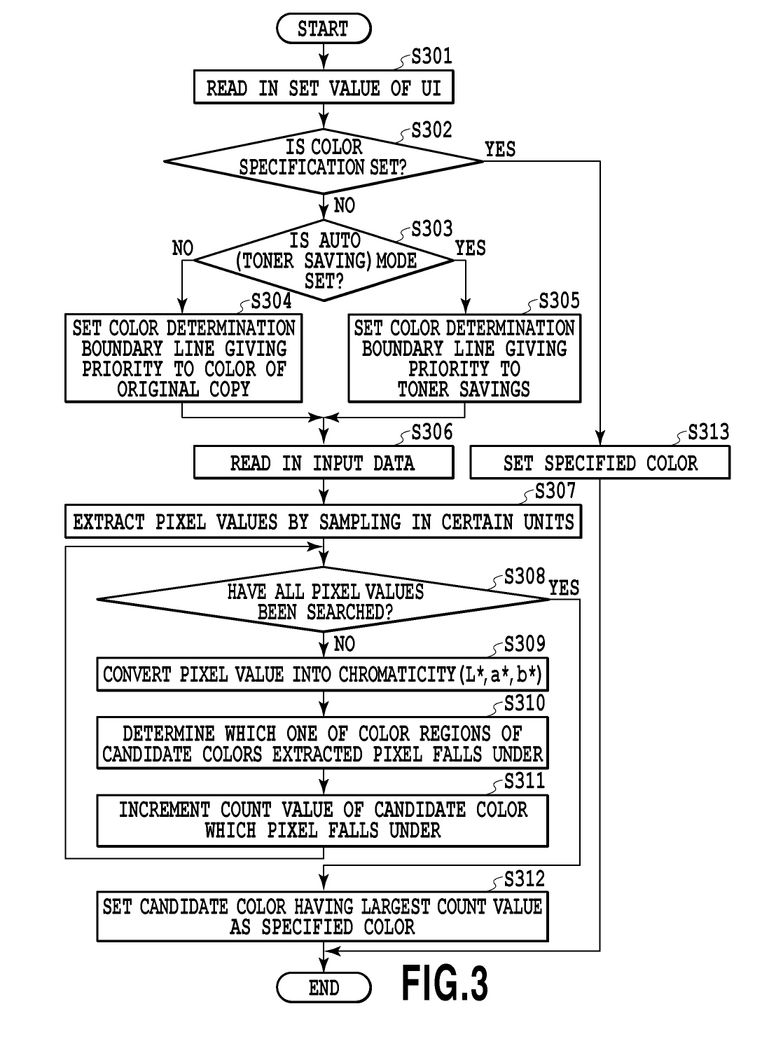

FIG. 3 is a flowchart illustrating the processing by the color determination unit 102 according to the first embodiment. A flow of the processing is executed in a case where the color determination unit 102 obtains a page of image data from the image data obtaining unit 101. To implement the processing, a CPU (Central Processing Unit) functions as the color determination unit 102 by loading a program stored in ROM (Read Only Memory) or the like of the image processing apparatus 100 into RAM (Random Access Memory), and executing the program.

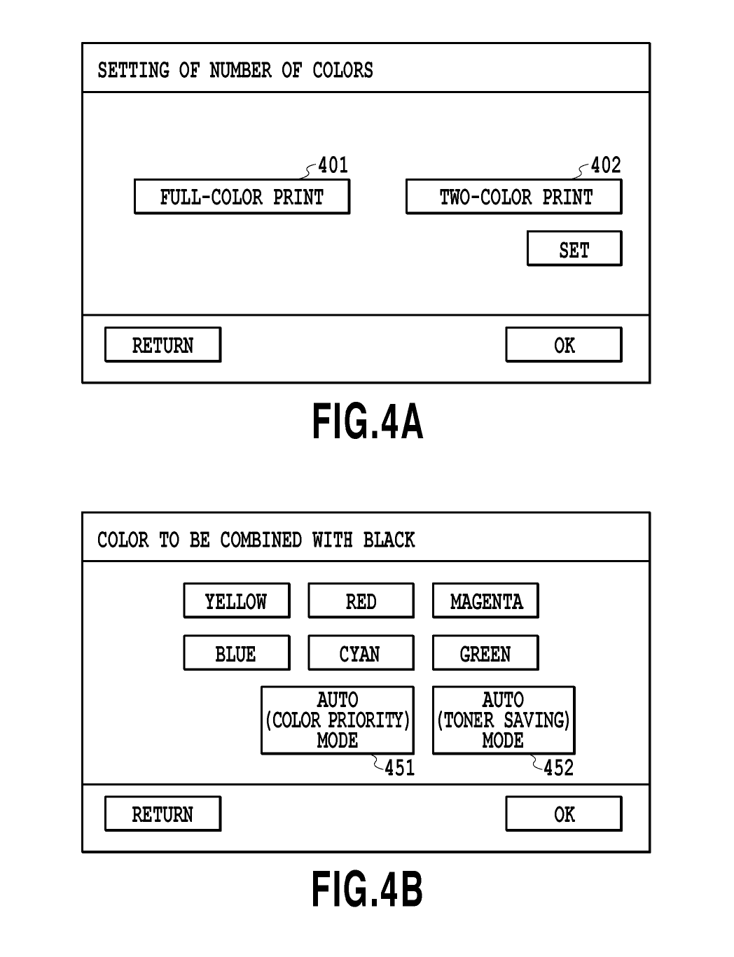

At step S301, the color determination unit 102 reads in a set value of UI (User Interface). The set value of the UI refers to a value set based on user's specification via the UI. FIGS. 4A and 4B illustrate an example of the UI displayed on the operation unit of the image forming apparatus. In FIG. 4A, a screen for setting of the number of colors is displayed. For full-color printing using CMYK color materials, the user selects “full-color print” mode 401. Meanwhile, for two-color printing, the user selects “two-color print” mode 402. In a case where the “two-color print” mode 402 is selected on a UI menu as illustrated in FIG. 4A, the color determination unit 102 reads in a user-specified value on a UI menu as illustrated in FIG. 4B, as a set value. Hereinafter, the processing of step S301 will be described as the processing of reading in the set value in a case where the “two-color print” mode 402 is selected in FIG. 4A.

The UI menu illustrated in FIG. 4B allows selecting a color (or a specified color) to be combined with black for the two-color printing. The user can select any color from among yellow, red, magenta, blue, cyan and green colors, for example. Also, in the embodiment, the UI menu is configured to further allow selection between “auto (color priority)” mode 451 and “auto (toner saving)” mode 452. The “auto (color priority)” mode refers to a mode of setting for automatic selection of the specified color, and also to a mode of setting in which the selection of the specified color is made giving priority to color contained in image data. The “auto (toner saving)” mode refers to a mode of setting for automatic selection of the specified color, and also to a mode of setting in which the selection of the specified color is made giving priority to toner savings for a reduction in toner consumption for image data printing. In other words, the UI menu is configured to allow switching between a first mode in which the color is paramount and a second mode in which the toner savings is paramount, according to a user command. Details will be described later. The user specifies any color from among the colors illustrated in FIG. 4B (including the “auto” modes), and the color determination unit 102 reads in the specified value as the set value. Note that the set value may be pre-specified by the user, or may be selected by the user at the time of printing.

At step S302, the color determination unit 102 determines whether or not the set value read in at step S301 indicates a particular specified color (for example, yellow, red, or the like). In other words, a determination is made as to whether the particular color, rather than the “auto (color priority)” mode 451 or the “auto (toner saving)” mode 452 illustrated in FIG. 4B, is selected. In a case of “Yes,” or if the particular specified color is set, the processing goes to step S313; on the other hand, in a case of “No,” the processing goes to step S303.

At step S303, the color determination unit 102 determines whether or not the set value read in at step S301 indicates the “auto (toner saving)” mode. In a case of “Yes,” the processing goes to step S305; on the other hand, in a case of “No,” the processing goes to step S304. Note that step S303 gives a negative result, “No,” if the set value indicates the “auto (color priority)” mode. In the embodiment, a region where a candidate color selectable as the specified color is selected is changed according to whether the toner saving mode or the color priority mode is set. Specific description will be given below.

At step S304, the color determination unit 102 sets a color determination boundary line giving priority to color of a document. As employed herein, the color determination boundary line refers to a line represented by a function indicating a boundary line between partial regions (hereinafter called color regions) divided by colors selectable as candidate colors, in the hue plane. Here, the color priority mode is set, and thus, as illustrated in FIG. 2, the color determination boundary line is set such that the boundary between the color regions (for example, yellow and red color regions) is uniform or substantially uniform. For example, in a case of the boundary line between yellow and red, in sRGB space, L*a*b* values of solid yellow color as RGB signal values (255, 255, 0) are set to (L_{y}, a_{y}, b_{y}). Also, L*a*b* values of solid red color as RGB signal values (255, 0, 0) are set to (Lᵣ, aᵣ, bᵣ). In this case, the boundary line between yellow and red is arranged in an intermediate portion between yellow hue and red hue, and thus, a function of the boundary line between yellow and red can be defined as Equation (1).

$$Y = \frac{( {b}_{y} + {b}_{r} )}{( {a}_{y} + {a}_{r} )} * X \qquad ( 1 )$$

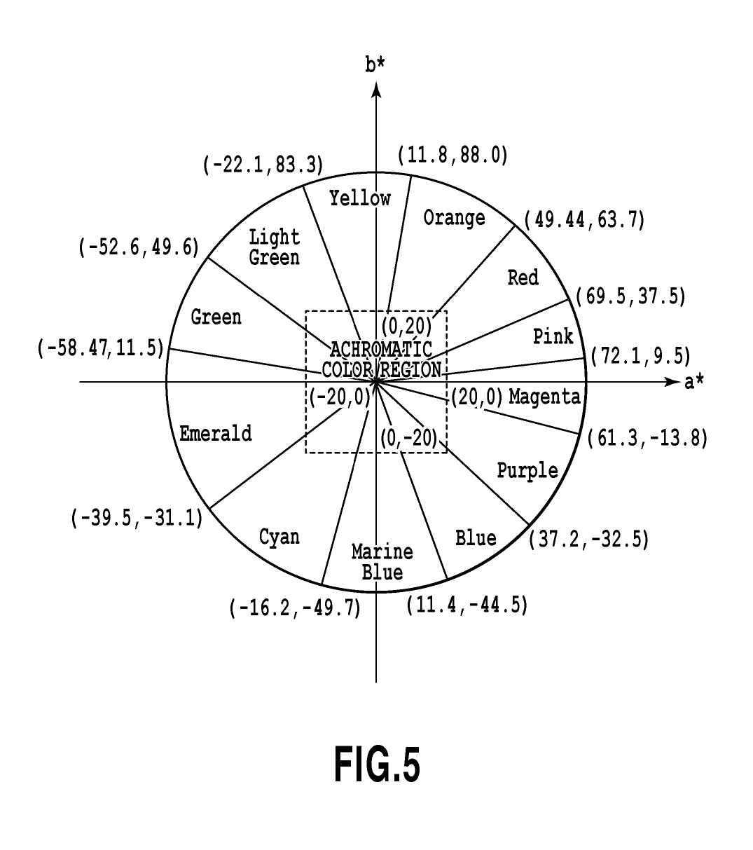

Here, Y denotes a value on a b* axis in a hue plane as illustrated for example in FIG. 2, and X denotes a value on an a* axis. Note that the same goes for a color space (for example, Adobe RGB or the like) other than the sRGB space. As illustrated in FIG. 5, also in a case where, besides CMYRGB, intermediate colors such as orange, pink and purple can be selected as candidate colors, the color determination boundary line is set such that the boundary between the color regions is uniform.

Note that the color determination boundary line is a line including an achromatic color region corresponding to an achromatic color. Here, the color determination unit 102 may be configured to set the achromatic color region at step S304 and exclude a pixel belonging to the set achromatic color region from a determination processing object at step S310 to be described later. For example, a region of +−Param1 in an a* direction and +−Param2 in a b* direction can be defined as the achromatic color region. In an example of FIGS. 2 and 5, Param1 and Param2 are both 20. The color determination boundary line is set as described above, and optionally, the achromatic color region is set, and thereby, at step S310 to be described later, a specified color of color close to that of the document is selected.

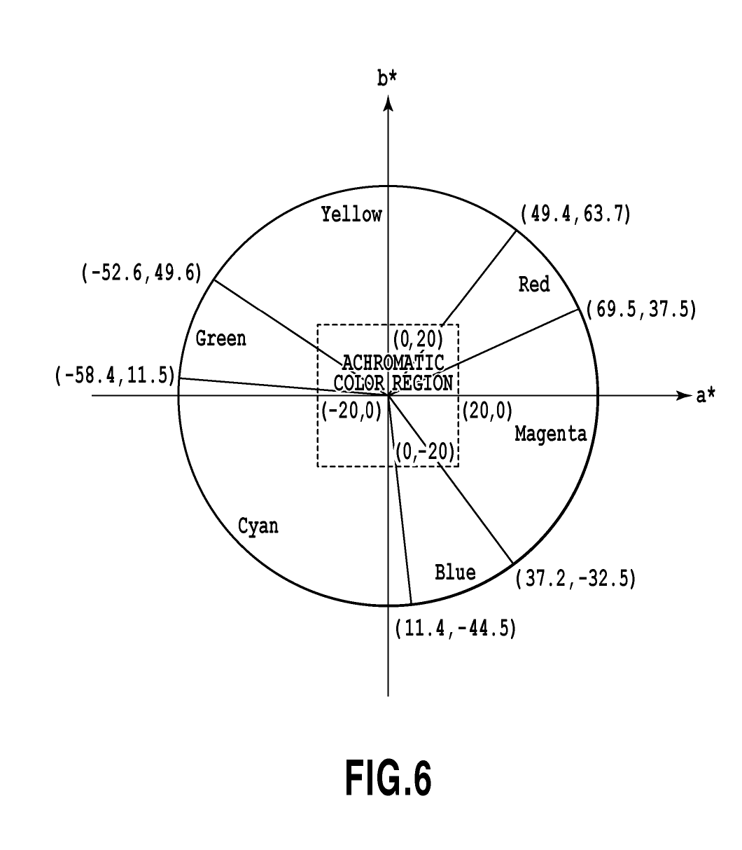

Meanwhile, at step S305, the toner saving priority mode is set, and thus, the color determination unit 102 sets a color determination boundary line to give priority to selection of a color having a toner saving effect as a candidate color. Here, as illustrated in FIG. 6, in the hue plane, the color determination boundary line is set such that color regions corresponding to RGB as secondary colors are narrower than color regions corresponding to CMY as primary colors of color materials. In other words, the color determination boundary line is set such that the RGB color regions required to be represented by a mixture of plural color materials are narrower than the color regions of the primary colors. For example, in a case of the boundary line between yellow and red, in the sRGB space, the L*a*b* values of the solid yellow color as the RGB signal values (255, 255, 0) are set to (L_{y}, a_{y}, b_{y}). Also, the L*a*b* values of the solid red color as the RGB signal values (255, 0, 0) are set to (Lᵣ, aᵣ, bᵣ). Then, the boundary line between yellow and red is arranged at a position such that the yellow region is wide and the red region is narrow. Therefore, the function of the boundary line between yellow and red can be defined for example as weighting as given below (in this case, a ratio between the yellow and red partial regions is 3 to 1).

$$Y = \frac{( {b}_{y} + 3 * {b}_{r} )}{( {a}_{y} + 3 * {a}_{r} )} * X \qquad ( 2 )$$

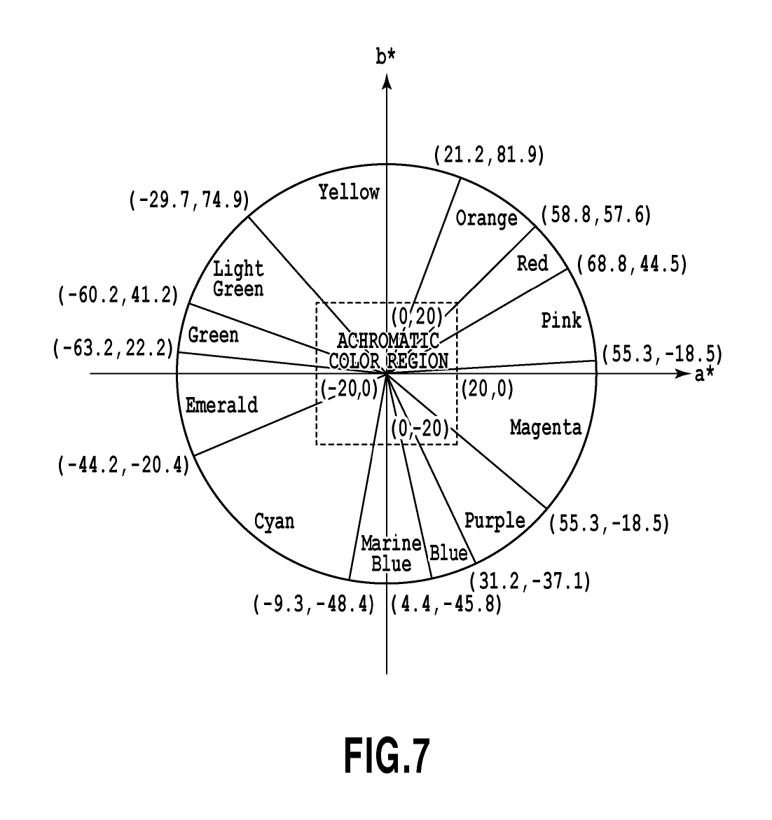

This increases the likelihood of selection of CMY colors as the primary colors of the color materials at step S310 to be described later, thus enabling a reduction in the amount of toner consumed. Note that, as illustrated in FIG. 7, in a case where, besides CMYRGB, the intermediate colors such as orange, pink and purple can be specified, the color determination boundary line is set such that the color regions become narrower in the following order: CMY, the intermediate colors (such as orange, pink and purple), and RGB. Also, as is the case with step S304, the color determination boundary line includes the achromatic color region corresponding to the achromatic color, and the color determination unit 102 may be configured to exclude a pixel belonging to the achromatic color region from the determination processing object at step S310 to be described later. Note that, as given herein, the ratios and color region determination methods are illustrative only, and any method may be used, provided that the color determination boundary line can be set such that the color regions of the primary colors are wider than those of the secondary colors.

At step S306, the color determination unit 102 reads in the RGB image data obtained from the image data obtaining unit 101.

At step S307, the color determination unit 102 extracts plural pixels by sampling the RGB image data at a predetermined sampling pitch (for example, one in ten pixels).

At step S308, the color determination unit 102 determines whether or not processing of steps S309 to S311 to be described later has been performed on all pixels extracted at step S307. In a case of “Yes,” the processing goes to step S312; on the other hand, in a case of “No,” the processing goes to step S309. The processing of steps S309 to S311 is to be performed on pixels of interest, one by one, of plural pixels extracted at step S307.

At step S309, the color determination unit 102 converts the pixel value (or RGB values) of each of the pixels extracted at step S307 into a pixel value in the L*a*b* space by a matrix operation or the like.

At step S310, the color determination unit 102 determines which one of plural color regions the pixel value obtained by conversion at step S309 belongs to. A specific example is described assuming that the pixel value is represented as coordinates (X, Y) in the hue plane and there are six patterns of specifiable colors, namely, CMYRGB. Refer also to FIGS. 2 and 6. In this case, for example, the gradients of the boundary lines of red and green as the candidate colors adjacent to yellow can be used to determine whether or not the color of the pixel falls under the yellow region. Namely, the gradients of the boundary lines between red and yellow and between red and green can be used. The color of the pixel as the determination processing object can be determined as falling under the yellow region, if the pixel is such that Equation (3) is established:

$$\frac{{b}_{yr}}{{a}_{yr}} * X > Y and \frac{{b}_{yg}}{{a}_{yg}} * X > Y \qquad ( 3 )$$

where b_{yr}/a_{yr} represents the gradient of the boundary line between yellow and red, and b_{yg}/a_{yg} represents the gradient of the boundary line between yellow and green.

Also, in a case where a determination is made as to whether or not the color of the pixel falls under the red region, the candidate colors adjacent to red are yellow and magenta, and thus, the color of the pixel can be determined as falling under the red region, if the pixel is such that Equation (4) is established:

$$\frac{{b}_{yr}}{{a}_{yr}} * X < Y and \frac{{b}_{rm}}{{a}_{rm}} * X > Y \qquad ( 4 )$$

where b_{yr}/a_{yr} represents the gradient of the boundary line between yellow and red, and bᵣₘ/aᵣₘ represents the gradient of the boundary line between red and magenta.

The same goes for other color regions. Such a determination is made for each color region, and, if a color region which the color of the pixel falls under is found, the processing comes to an end. Also in a case where the intermediate colors (such as pink and purple) other than CMYRGB are set as colors selectable as the candidate colors, the color determination boundary lines corresponding to the selectable colors are set thereby to enable using the same method to make a determination. Also, as mentioned previously, in a case where the color determination boundary line includes the achromatic color region corresponding to the achromatic color, the color determination unit 102 may be configured to exclude a pixel belonging to the achromatic color region from the determination processing object. For example, in a case where the boundary line of the achromatic color region is set as +−Param1 in the a* direction and +−Param2 in the b* direction, the color of the pixel can be determined as falling under the achromatic color region, if the pixel is such that Equation (5) is established.

|a*|<Param1 and |b|<Param2 (5)

At step S311, the color determination unit 102 increments the count value of the color region which at step S310 the color of the pixel falls under, among the count values of the color regions held for each candidate color, and the processing returns to step S308.

At step S312, the color determination unit 102 determines the candidate color having the largest count value among the count values for each candidate color, and sets the determined candidate color as the specified color for two-color printing.

At step S313, the color determination unit 102 sets, as the specified color, a color specified by the set value read from a UI menu 802 at step S301.

In a case where there are plural pages of image data to be printed, the processing from step S301 is repeated again for the next page. In the embodiment, therefore, the specified color can be automatically changed for each page.

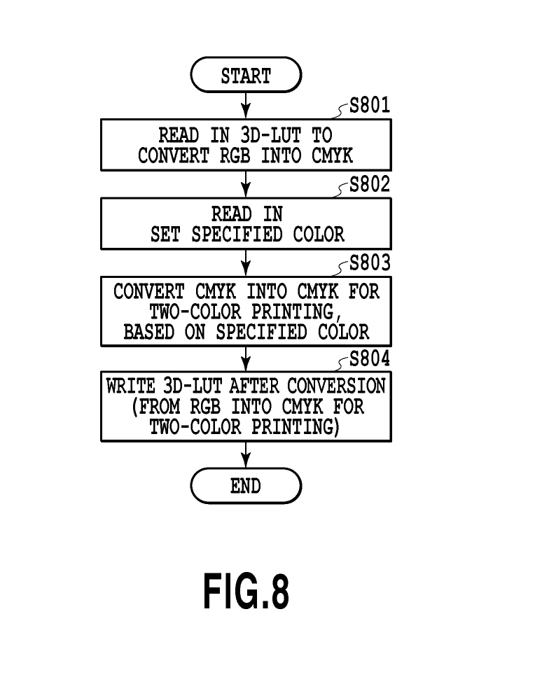

FIG. 8 is a flowchart illustrating processing by the two-color conversion table generation unit 103 according to the first embodiment.

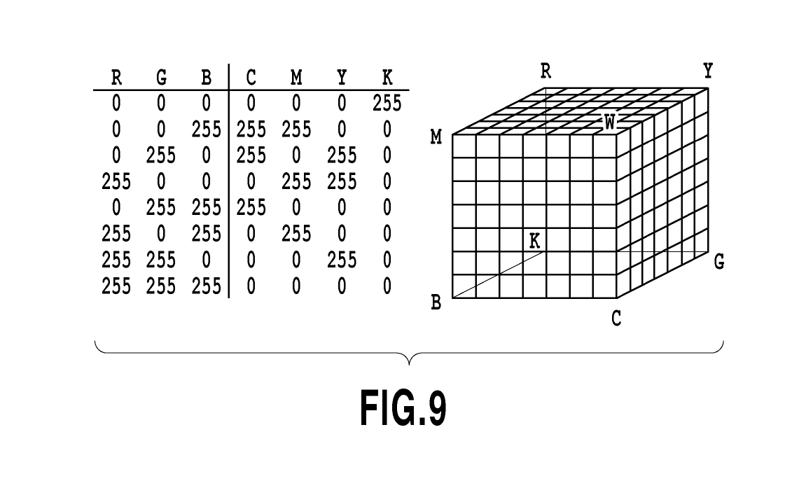

At step S801, the two-color conversion table generation unit 103 reads in a color conversion table to convert RGB image data for use in full-color printing into CMYK image data. The color conversion table defines a cube in a three-dimensional color space defined by RGB signals, and can determine coordinates in the cube in the three-dimensional color space according to the values of 8 bits of RGB data, as illustrated in FIG. 9. Eight vertexes of the cube indicate red, green, blue, yellow, magenta, cyan, black, and white, respectively. Also, the color conversion table has grid points, for example 16×16×16 in number, defined by RGB values of input data, and stores CMYK values corresponding to the grid points, as table data. For example in FIG. 9, the CMYK values (0, 255, 255, 0) are stored as the table data corresponding to the RGB values (255, 0, 0).

At step S802, the two-color conversion table generation unit 103 reads in the specified color set at step S312 or S313.

At step S803, the two-color conversion table generation unit 103 converts the CMYK values for full-color printing stored in the color conversion table read in at step S801, into CMYK values for two-color printing, according to the specified color read in at step S802. For example, if the CMYK values for full-color printing have 16×16×16 grid points, the CMYK values for full-color printing are converted into 4096 CMYK values for two-color printing in total. Specifically, a matrix operation is performed on the CMYK values corresponding to each grid point. For example in a case where red is set as the specified color, a matrix operation as given below is used to convert the CMY values stored in the color conversion table into the M value and the Y value as the color values which form red, and to convert the K value so as to output the K value as it is.

$$( \begin{matrix}C \\ M \\ Y \\ K\end{matrix} ) = ( \begin{matrix}0 & 0 & 0 & 0 \\ 0.33 & 0.33 & 0.33 & 0 \\ 0.33 & 0.33 & 0.33 & 0 \\ 0 & 0 & 0 & 1\end{matrix} ) * ( \begin{matrix}C \\ M \\ Y \\ K\end{matrix} ) \qquad ( 6 )$$

In a case where green is set as the specified color, the following conversion is performed.

$$( \begin{matrix}C \\ M \\ Y \\ K\end{matrix} ) = ( \begin{matrix}0.33 & 0.33 & 0.33 & 0 \\ 0. & 0 & 0 & 0 \\ 0.33 & 0.33 & 0.33 & 0 \\ 0 & 0 & 0 & 1\end{matrix} ) * ( \begin{matrix}C \\ M \\ Y \\ K\end{matrix} ) \qquad ( 7 )$$

In a case where blue is set as the specified color, the following conversion is performed.

$$( \begin{matrix}C \\ M \\ Y \\ K\end{matrix} ) = ( \begin{matrix}0.33 & 0.33 & 0.33 & 0 \\ 0.33 & 0.33 & 0.33 & 0 \\ 0 & 0 & 0 & 0 \\ 0 & 0 & 0 & 1\end{matrix} ) * ( \begin{matrix}C \\ M \\ Y \\ K\end{matrix} ) \qquad ( 8 )$$

In a case where cyan is set as the specified color, the following conversion is performed.

$$( \begin{matrix}C \\ M \\ Y \\ K\end{matrix} ) = ( \begin{matrix}0.33 & 0.33 & 0.33 & 0 \\ 0 & 0 & 0 & 0 \\ 0 & 0 & 0 & 0 \\ 0 & 0 & 0 & 1\end{matrix} ) * ( \begin{matrix}C \\ M \\ Y \\ K\end{matrix} ) \qquad ( 9 )$$

In a case where magenta is set as the specified color, the following conversion is performed.

$$( \begin{matrix}C \\ M \\ Y \\ K\end{matrix} ) = ( \begin{matrix}0 & 0 & 0 & 0 \\ 0.33 & 0.33 & 0.33 & 0 \\ 0 & 0 & 0 & 0 \\ 0 & 0 & 0 & 1\end{matrix} ) * ( \begin{matrix}C \\ M \\ Y \\ K\end{matrix} ) \qquad ( 10 )$$

In a case where yellow is set as the specified color, the following conversion is performed.

$$( \begin{matrix}C \\ M \\ Y \\ K\end{matrix} ) = ( \begin{matrix}0 & 0 & 0 & 0 \\ 0 & 0 & 0 & 0 \\ 0.33 & 0.33 & 0.33 & 0 \\ 0 & 0 & 0 & 1\end{matrix} ) * ( \begin{matrix}C \\ M \\ Y \\ K\end{matrix} ) \qquad ( 11 )$$

Also, the following conversion is adaptable to orange as the intermediate color.

$$( \begin{matrix}C \\ M \\ Y \\ K\end{matrix} ) = ( \begin{matrix}0 & 0 & 0 & 0 \\ 0.165 & 0.165 & 0.165 & 0 \\ 0.33 & 0.33 & 0.33 & 0 \\ 0 & 0 & 0 & 1\end{matrix} ) * ( \begin{matrix}C \\ M \\ Y \\ K\end{matrix} ) \qquad ( 12 )$$

Also for other intermediate colors (such as pink and purple), the same method can be used for conversion.

At step S804, the two-color conversion table generation unit 103 generates the CMYK values for two-color printing converted at step S803, as table data for the two-color conversion table. The two-color conversion table thus generated is written to the two-color conversion table holding unit 104.

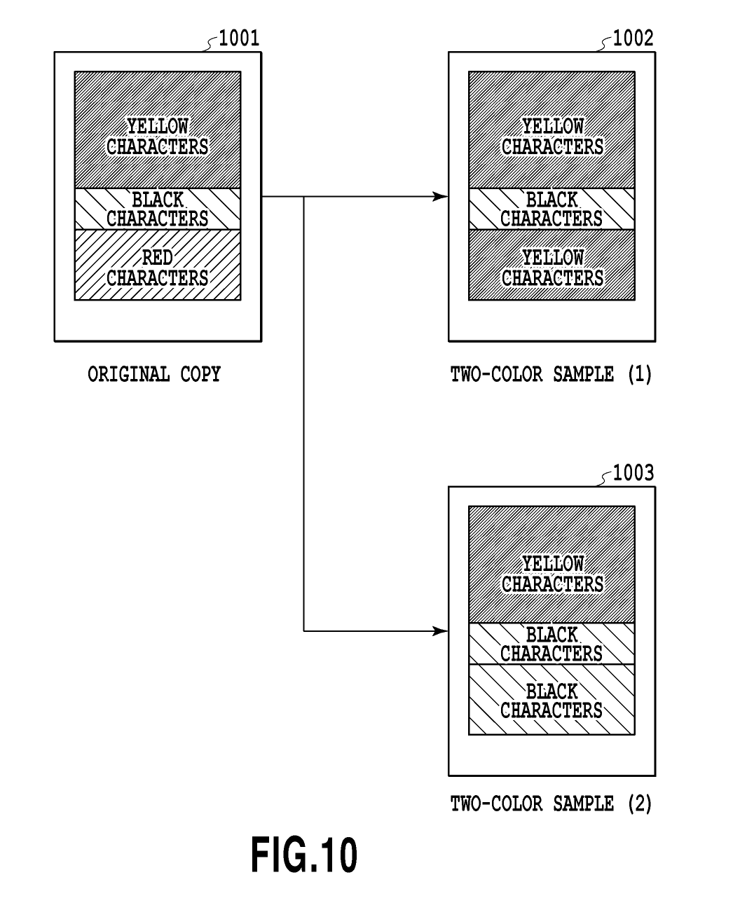

FIG. 10 illustrates results of processing by two-color conversion in the first embodiment. For example, in a case where a document 1001 is formed of yellow characters, black characters and red characters and the proportion of the yellow characters is largest, yellow is set as the specified color regardless of whether the color priority mode or the toner saving priority mode is set. Therefore, the yellow characters and the red characters are both converted into the specified color, i.e. yellow, and the black characters are converted into black, and thus, a two-color sample 1002 is printed. A two-color sample (2) 1003 of FIG. 10 will be described in a second embodiment.

According to the first embodiment, as described above, a device to determine a color which forms the document and perform automatic switching between modes of setting of a specified color is provided. In this case, the total amount of toner consumed for two-color printing can be reduced by performing the color determination giving priority to the toner saving effect. Also, according to the embodiment, for the determination of the specified color, switching can be performed between “the color determination giving priority to the color of the document” and “the color determination giving priority to the toner saving effect.” Thereby, the specified color can be automatically set according to user's intention. Also, such a device for automatic determination can automatically set the specified color according to the user's intention, even in a case where there are plural pages of print data.

### Second Embodiment

In the first embodiment, description has been given with regard to a configuration in which the device to determine a color which forms a document and perform automatic switching between modes of setting of a specified color is provided and, for the determination of the specified color, switching can be performed between “the color determination giving priority to the color of the document” and “the color determination giving priority to the toner saving effect.” Thereby, as illustrated in FIG. 10, in a case where the document 1001 is formed of the yellow characters, the black characters and the red characters and the proportion of the yellow characters is largest, in the first embodiment, the yellow characters and the red characters are converted into the specified color, i.e. Y, and the black characters are converted into K. Description has been given with regard to an example in which the two-color sample 1002 is consequently printed. In the first embodiment, however, the yellow characters and the red characters are both printed in a chromatic color (here, yellow), and thus, a portion which is not intended to be emphasized (in this case, the red characters) may also be printed in two colors. For example in a case of the document 1001 illustrated in FIG. 10, the user may desire to represent the yellow characters alone as important keywords in the chromatic color and print the rest in monochrome. In other words, in some cases, it may be desired to produce a printed output such as the two-color sample 1003. In the second embodiment, focusing on this respect, mention will be made of an embodiment in which the automatically determined specified color alone in the document is emphasized.

A block diagram of assistance in explaining a configuration of the image processing apparatus 100 according to the second embodiment will be mentioned below, since the color determination unit 102 and the color conversion unit 105 alone perform different processing from the first embodiment. The remaining configuration is the same as that in the first embodiment.

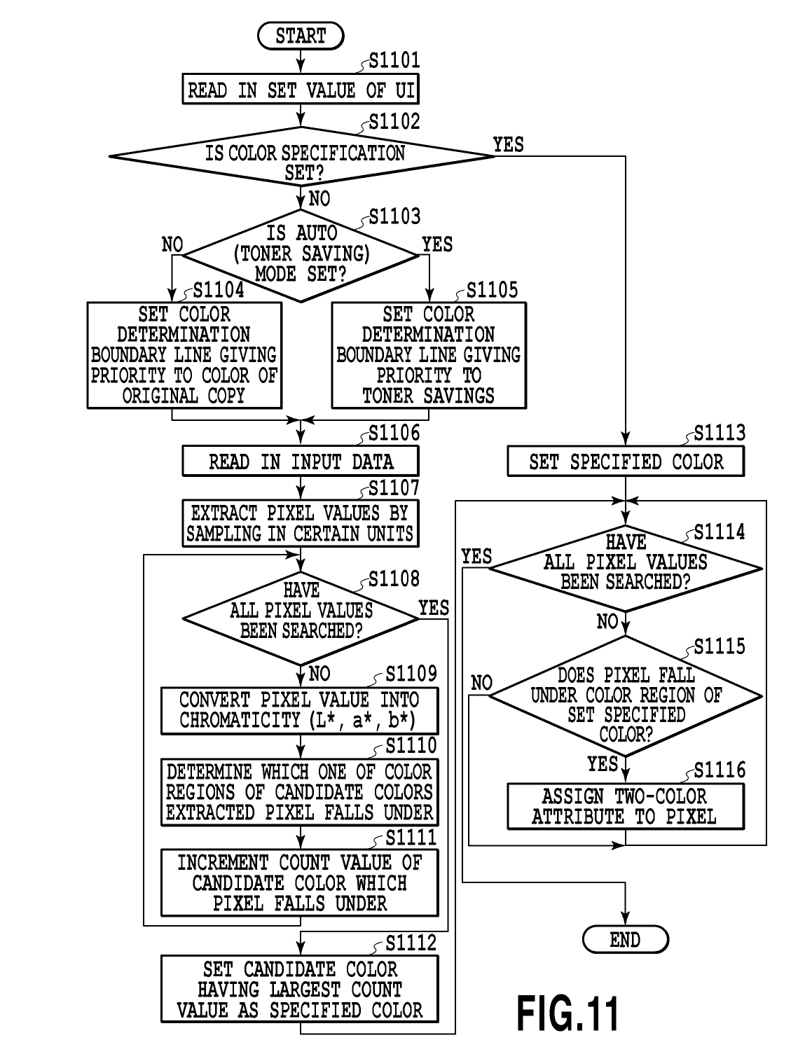

The color determination unit 102 extracts a pixel value by sampling input RGB image data, and converts the pixel value into the L*a*b* space. Then, as illustrated in FIG. 2, a candidate color for each pixel is determined in the hue plane. As described in the first embodiment, the candidate colors may be CMYRGB, or the intermediate colors such as orange, pink and purple may be added. Also in the second embodiment, in the same manner as the first embodiment, results of determination of each sampled pixel are counted for each candidate, and the candidate color having the largest count value is set as the specified color. Further, in the second embodiment, an attribute is assigned to the pixel falling under the set specified color thereby to allow the color conversion unit 105 to switch between color conversion modes. Details will be described later with reference to a flowchart of FIG. 11.

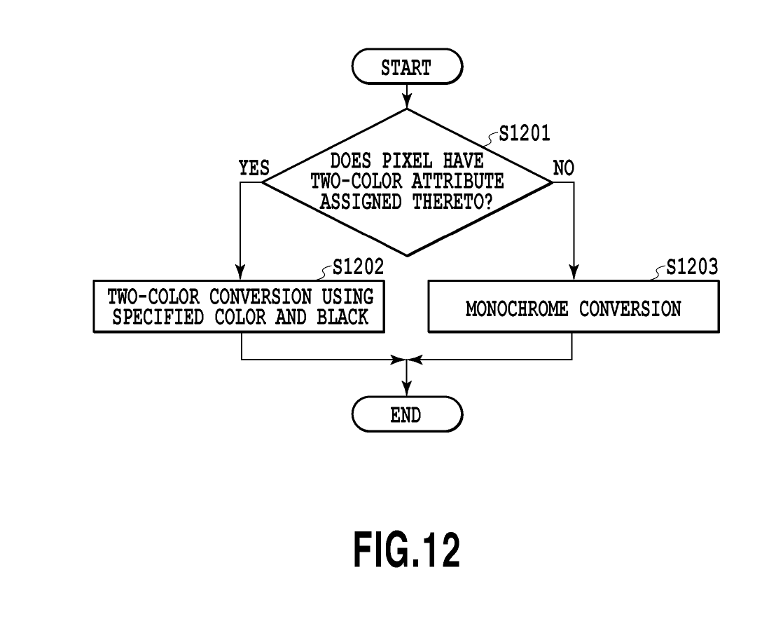

The color conversion unit 105 determines whether or not the input RGB image data has the attribute assigned thereto by the color determination unit 102, for each pixel, thereby to switch between color conversion for two-color printing and monochrome conversion. Details will be described later with reference to a flowchart of FIG. 12.

FIG. 11 is a flowchart illustrating processing by the color determination unit 102 according to the second embodiment. A flow of the processing is executed in a case where a page of image data is obtained from the image data obtaining unit 101.

Since steps S1101 to S1113 are the same as steps S301 to S313 in the first embodiment, description will be omitted.

At step S1114, the color determination unit 102 determines whether or not processing of steps S1115 and S1116 to be described later has been performed on all pixels extracted at step S1107. Note that, in a case where at step S1113 a specified color is set, pixels sampled in certain units may be set as processing objects, as is the case with step S1107, or all pixels may be set as processing objects. If at step S1114 a result of determination shows “Yes,” the processing comes to an end; on the other hand, in a case of “No,” the processing goes to step S1115. The processing of steps S1115 and S1116 is to be performed on pixels of interest, one by one, extracted from the obtained image data.

At step S1115, the color determination unit 102 determines whether or not a pixel of interest falls under the color region of the specified color set at steps S1112 and S1113. In a case of “Yes,” the processing goes to step S1116; on the other hand, in a case of “No,” the processing moves on to the next pixel and returns to step S1115.

At step S1116, the color determination unit 102 assigns a two-color attribute to the pixel of interest. For example, the two-color attribute is appended to attribute information generated by the image data obtaining unit 101, at the pixel position of the pixel of interest. This allows the color conversion unit 105 to switch between the color conversion modes.

FIG. 12 is a flowchart illustrating processing by the color conversion unit 105 according to the second embodiment. Note that the following processing of steps S1201 to S1203 is to be performed on pixels of interest, one by one, of the obtained image data.

At step S1201, the color conversion unit 105 determines whether or not a target pixel of RGB image data has the two-color attribute assigned thereto. For example, a determination is made as to whether or not the attribute information of the target pixel has the two-color attribute appended thereto. In a case of “Yes,” the processing goes to step S1202; on the other hand, in a case of “No,” the processing goes to step S1203.

At step S1202, the color conversion unit 105 performs conversion on the pixel determined as “Yes” at step S1201, to convert the RGB value into a CMYK value for two-color printing by referring to the two-color conversion table held in the two-color conversion table holding unit 104.

Meanwhile, at step S1203, the color conversion unit 105 performs conversion on the pixel determined as “No” at step S1201, to convert the RGB value into a K value. Specifically, conversion is performed on the CMYK value corresponding to each grid point, for example by using a matrix operation as given below.

$$( \begin{matrix}C \\ M \\ Y \\ K\end{matrix} ) = ( \begin{matrix}0 & 0 & 0 & 0 \\ 0 & 0 & 0 & 0 \\ 0 & 0 & 0 & 0 \\ 0.25 & 0.25 & 0.25 & 0.25\end{matrix} ) * ( \begin{matrix}C \\ M \\ Y \\ K\end{matrix} ) \qquad ( 13 )$$

Results of processing by two-color conversion in the second embodiment are illustrated with reference to FIG. 10. For example, in a case where the document 1001 is formed of the yellow characters, the black characters and the red characters and the proportion of the yellow characters is largest, the yellow character portion alone is converted into the specified color, i.e. Y. The other characters are converted into K, and thus, the two-color sample 1003 is printed.

According to the second embodiment, as described above, in addition to the advantageous effects described in the first embodiment, it is possible to represent a character portion of a specified color alone in a chromatic color and print the rest other than the specified color in monochrome. This enables two-color printing emphasizing the automatically determined specified color alone in a document, as well as reducing the total amount of toner consumed for two-color printing by automatic determination of plural pages, according to the user's intention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-267688, filed Dec. 25, 2013, which is hereby incorporated by reference wherein in its entirety.

What is claimed is:

1. An image processing apparatus comprising:
a determination unit configured to determine which one of a plurality of color divisions a color of each of a plurality of pixels contained in image data falls under; and
a decision unit configured to decide a color material for use in printing of the image data, based on results of the determination by the determination unit,
wherein the plurality of color divisions include a division of a primary color which is a color of a color material usable for the printing, and a division of a secondary color which is a color formed by a combination of the colors of the color materials, and the division of the primary color is wider than the division of the secondary color.

2. An image processing apparatus comprising:
a setting unit configured to set color regions obtained by dividing a color space into a plurality of colors;
a determination unit configured to determine a color region having the highest content of a color which forms image data, among the color regions set by the setting unit; and
a decision unit configured to decide a color corresponding to the region having the highest content of the color determined by the determination unit as a specified color for use in printing of the image data,
wherein the setting unit sets the color regions obtained by dividing the color space such that a region of a primary color as a color corresponding to a color material for use in the printing is wider than a region of a secondary color as a color corresponding to a combination of a plurality of colors of color materials for use in the printing.

3. The image processing apparatus according to claim 2, wherein the setting unit sets the color regions in a two-dimensional color plane defined by two parameters corresponding to two components associated with hue in the color space.

4. The image processing apparatus according to claim 2, wherein the determination unit makes the determination using image data obtained by converting the image data into a color space having one achromatic color axis in a three-dimensional color space.

5. The image processing apparatus according to claim 2, wherein the determination unit determines that a color region containing the largest number of pixels obtained by sampling pixels contained in the image data is the color region having the highest content of the color which forms the image data.

6. The image processing apparatus according to claim 5, wherein the determination unit determines that a color region containing the largest number of pixels exclusive of pixels corresponding to an achromatic color is the color region having the highest content of the color which forms the image data.

7. The image processing apparatus according to claim 2, further comprising a control unit configured to command a printing unit to perform two-color printing using the specified color determined by the determination unit.

8. The image processing apparatus according to claim 7, wherein the control unit commands the printing unit to perform the two-color printing using the specified color and the achromatic color.

9. The image processing apparatus according to claim 7, wherein the control unit commands the printing unit to print the image data converted into a color space corresponding to the color material, and converted into two colors based on the specified color.

10. The image processing apparatus according to claim 7, wherein the control unit commands the printing unit to print the image data obtained by converting a chromatic color other than the specified color into an achromatic color.

11. An image processing apparatus comprising:
a setting unit configured to set color regions obtained by dividing a color space into a plurality of colors;
a determination unit configured to determine a color region having the highest content of a color which forms image data, among the color regions set by the setting unit; and
a decision unit configured to decide a color corresponding to the region having the highest content of the color determined by the determination unit as a specified color for use in printing of the image data,
wherein the setting unit performs, in response to a user command, switching between:
a first mode of setting of the color regions obtained by equally dividing the color space into the plurality of colors; and
a second mode of setting of the color regions obtained by dividing the color space such that a region of a primary color as a color corresponding to a color material for use in the printing is wider than a region of a secondary color as a color corresponding to a combination of a plurality of colors of color materials for use in the printing.
